(19) United States
(12) Patent Application Publication
(10) Pub. No.: US 2010/0107627 A1
(43) Pub. Date: May 6, 2010

(54) BUOYANCY ENERGY STORAGE AND ENERGY GENERATION SYSTEM

(75) Inventor: John Paul MORGAN, Toronto (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: Eric Andres MORGAN, Alcobendas, Madrid (ES)

(21) Appl. No.: 12/614,183

(22) Filed: Nov. 6, 2009

Related U.S. Application Data
(60) Provisional application No. 61/111,832, filed on Nov. 6, 2008.
(60) Provisional application No. 61/223,792, filed on Jul. 8, 2009.

(51) Int. Cl. F03B 17/02; B63B 35/44; B64B 1/50; B64B 1/62; B63B 21/24; B65H 75/48

(52) U.S. Cl. 60/495; 114/264; 244/33; 114/294; 242/390.8

(57) ABSTRACT

An energy generation and storage system that uses a buoyant balloon suspended in a fluid and connected by a tether to a reel. The tether is taut and keeps the balloon from rising due to the buoyant force. A motor can do work to wind the reel in such a way that the balloon is pulled down against the buoyant force. Energy can be extracted from the system by allowing the balloon to rise, pulling on the tether and turning the reel that is connected to a generator. The generator and the motor can be the same unit, or they can be independent units which both connect to the reel.

### CROSS REFERENCE TO RELATED APPLICATIONS

This application claims the benefit of priority of U.S. Provisional Patent Application No. 61/111,832 filed Nov. 6, 2008 and of U.S. Provisional Patent Application No. 61/223,792 filed Jul. 8, 2009, which are incorporated herein by reference in their entirety.

### FIELD OF THE INVENTION

The present invention relates generally to energy storage. More particularly, the present invention relates to storing energy by doing work against the buoyant force on an object, such as a balloon, when it is immersed in a fluid such as water or air.

### BACKGROUND OF THE INVENTION

Every year, all over the world, the generation capacity of alternative energy sources such as wind and solar power is increasing. However, their widespread adoption is often limited by the fact that the energy that is produced by alternative sources is intermittent. Sources of energy that can produce energy on demand, called dispatchable sources, are a requirement for infrastructure level power projects. Without a reliable way to store energy from intermittent energy sources, alternative energy sources will remain marginal. One solution to this limitation is an energy storage system, but no energy storage systems exist that is economical enough to offset the extra costs incurred in installing and maintaining such systems. While much work is being done to improve chemical batteries such as lithium ion batteries and ultra capacitors, these solutions require expensive materials and processes to manufacture.

Two means of energy storage that do not use chemical mechanism to store energy are pumped water energy storage and pumped air energy storage. In pumped water storage, energy is stored by pumping water up from a low reservoir into an elevated reservoir. Energy is extracted from such a system by allowing the water to flow from the elevated reservoir back into the lower reservoir via turbines that spin generators, creating electricity. In pumped air storage, energy is stored by pumping air into a pressurized vessel. Energy is extracted from the system by allowing air to escape the pressurized vessel, again spinning turbines as the air moves. The turbines in turn spin generators that make electricity. Some proposals to place air bladders inside a body of water have been made whereby the pressure from the body of water would provide the pressure for pumped air storage. This requires the construction of high-pressure gas pipelines to connect pumps and turbines on shore to the deep underwater storage bladder. Both pumped air systems and pumped water systems require turbines to function, these turbines can be costly to build and maintain. To date, there are no pumped water or pumped air energy storage systems that are economical, scalable, and deployable in a wide variety of locations.

Improvements in energy storage systems are therefore desirable.

### SUMMARY OF THE INVENTION

The present disclosure includes an exemplary energy storage system that includes a buoyant balloon suspended in a fluid and connected by a tether to a reel. The tether keeps the balloon from rising due to the buoyant force. A motor can wind the reel in such a way so that the balloon is pulled down against the buoyant force. Energy can be extracted from the system by allowing the balloon to rise, pulling on the tether and turning the reel, which is connected to a generator. The generator and the motor can be the same unit, or they can be independent units which both connect to the reel.

The system of the present disclosure can have many variants. A first variant uses submerged air filled balloons connected via pulleys anchored at the bottom of the body of water to reels disposed either on barges or on land. A second variant uses aerial hydrogen or helium filled balloons connected to a reel on the ground. The variants share many common technical features and each has advantages and disadvantages. The aerial systems can be installed anywhere on land, but they require hydrogen and their stored energy density (measured in kilowatt-hours per cubic meter) is low. The aerial systems can be suitable for power requirements in remote locations. The submerged systems can use air filled balloons, which is less expensive than helium or hydrogen filled balloons. As the buoyant force on an air filled balloon is high, they will have a high energy density. However, they must be installed in a deep body of water. The submerged systems will likely be well suited for large centralized power storage systems that service major cities near the ocean or any other suitable body of water.

In a first aspect, the present disclosure provides an energy storage system, which comprises a buoyant object to be disposed in a body of water, the body of water overlying a seafloor; a tether to secure to the buoyant object; a motor operationally connectable to the tether to lower the buoyant object in the water to obtain a lowered buoyant object, the motor being disposed outside the water; a generator operationally connectable to the tether, the generator to generate power upon release of the lowered buoyant object and a rise of the buoyant object in the water, the generator being disposed outside the water; and a pulley disposed on the seafloor, the pulley to guide the tether from the motor and the generator to the buoyant object.

The system can further comprise a reel, the reel to connect to the motor and to the generator. The reel is to reel-in a length of the tether upon being turned by the motor to lower the buoyant object in the water. The reel is also to reel-out the length of the tether and to turn the generator upon the rise of the buoyant object in the water. The buoyant object can be a balloon.

The balloon can occupy an initial volume when subjected to atmospheric pressure, the balloon being filled with air at a first pressure, the balloon to be lowered in the water to a pre-determined depth, the water exerting a second pressure on the balloon at the pre-determined depth, the first pressure being greater than the second pressure to allow the balloon to substantially maintain its initial volume when at the pre-determined depth.

The motor can include one of an electrical motor and a combustion engine. The generator can include an electrical generator.

The system can further comprise a floating structure to be disposed on the water, the motor and the generator being disposed on the floating structure.

The body of water can be adjacent a shore, the motor and the generator being disposed on the shore.

The system can further comprise a ballast connected to the pulley, the ballast to secure the pulley to the seafloor.

The buoyant object can be a stiff-walled structure.

In a second aspect of the disclosure, there is provided an energy storage system that comprises a buoyant object to be disposed in a fluid; a tether to secure to the buoyant object; and a motor-generator unit operationally connectable to the tether, the motor-generator unit to receive electrical power to lower the buoyant object in the fluid to obtain a lowered buoyant object, the motor-generator unit to generate electrical power upon a release of the lowered buoyant object and a rise of the lowered buoyant object in the fluid.

The system can further comprise a reel, the reel to connect to the motor-generator unit, the reel to reel-in a length of the tether upon being turned by the motor-generator unit to lower the buoyant object in the fluid, the reel to reel-out the length of the tether and to turn the motor-generator unit upon the rise of the buoyant object in the fluid.

The buoyant object buoyant object can be a balloon and the fluid can be air. The balloon can be filled with at least one of hydrogen and helium.

The balloon can have a volume, the volume being variable from an initial volume to an expanded volume, the balloon having a negative buoyancy at the initial volume and a positive buoyancy at the expanded volume. The volume of the balloon can increase from the initial volume to the expanded volume upon absorption of thermal energy, the expansion of the volume causing the balloon to rise in the air. The balloon can absorb thermal energy upon being illuminated by the Sun.

In a third aspect, there is provided an energy storage system that comprises: a buoyant object to be disposed in a fluid; a tether to secure to the buoyant object; and a mechanical unit including at least one of a hand crank, a water turbine, and a wind turbine, the mechanical unit being operationally connectable to the tether to lower the buoyant object in the fluid to obtain a lowered buoyant object; a generator operationally connectable to the tether, the generator to generate power upon release of the lowered buoyant object and a rise of the buoyant object in the fluid, the generator being disposed outside the water; and a pulley to guide the tether from the motor and the generator to the buoyant object.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 shows a perspective of an exemplary embodiment of a submerged balloon buoyancy energy storage system;

FIG. 2 shows a two-dimensional side view of the system of FIG. 1;

FIG. 3a-3c shows the system of FIG. 1 at different stages of operation;

FIG. 4 shows another exemplary embodiment of a submerged balloon energy storage system;

FIG. 5a shows yet another exemplary embodiment of a submerged balloon energy storage system;

FIG. 5b shows an additional exemplary embodiment of a submerged balloon energy storage system;

FIG. 6a shows another exemplary embodiment of a submerged balloon energy storage system, which comprises a ballast;

FIG. 6b shows yet another exemplary embodiment of a submerged balloon energy storage system, which comprises a sack ballast;

FIG. 7a shows an assembly of a spherical balloon connected to a tether, the assembly being usable in a submerged balloon energy storage system and an aerial balloon energy storage system;

FIG. 7b shows an assembly of hollow pipe sections that can be used as a buoyant object;

FIG. 7c shows a single hollow pipe section;

FIGS. 8a-8c show an exemplary embodiment of floating balloon energy storage system at different stages of operation;

FIG. 9 shows another embodiment of floating balloon energy storage system;

FIG. 10 show another exemplary embodiment of a submerged balloon energy storage system;

FIG. 11 shows an exemplary embodiment where an hydroelectric power system is coupled to a submerged balloon energy storage system;

FIG. 12 shows an exemplary embodiment of an aerial buoyancy energy storage system;

FIGS. 13A-C show another exemplary embodiment of an aerial buoyancy energy storage system at different stages of operation;

FIG. 14 shows yet another exemplary embodiment of an aerial buoyancy energy storage system; and

FIG. 15 shows a graph comparing the electrical output of a continual power source to the shifted output of a continual source using storage to offset delivery.

### DETAILED DESCRIPTION OF THE INVENTION

Buoyancy is a well understood phenomenon. Buoyancy is the upward force exerted on an object when it is submerged in a fluid having a higher density than that of the object. This is the force that lifts helium balloons in the air and the force that causes boats to float on water. A buoyant force is given by the following equation: F=mg−pVg where m is the mass of the object in question, g is the local gravitational acceleration, p is the density of fluid, V is the volume of fluid displaced and F is the buoyant force. In fluids with non-uniform density—as is the case with the atmosphere, which decreases in density gradually as altitude increases—the formula is more complicated to reflect this. The general case that is always true is that the buoyant force on an object is equal to the difference between the force of gravity on an object and the force of gravity on the fluid that the object displaces. If the volume of fluid displaced weighs more than the object displacing the fluid, then the object will be subject to an upward force. In general, an object is said to have a positive buoyancy if it tends to rise in the fluid in which it is submerged. An object having a negative buoyancy is one that tends to sink in the fluid in which it is submerged.

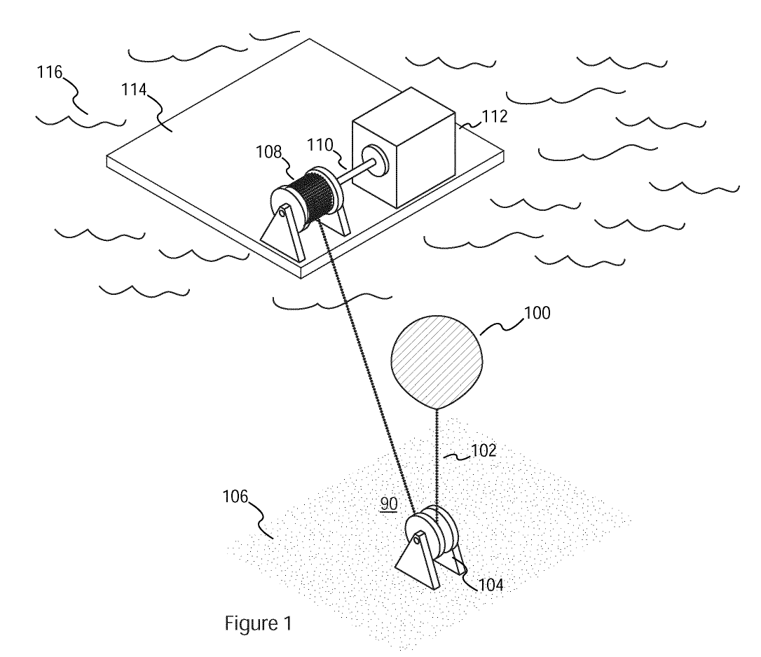

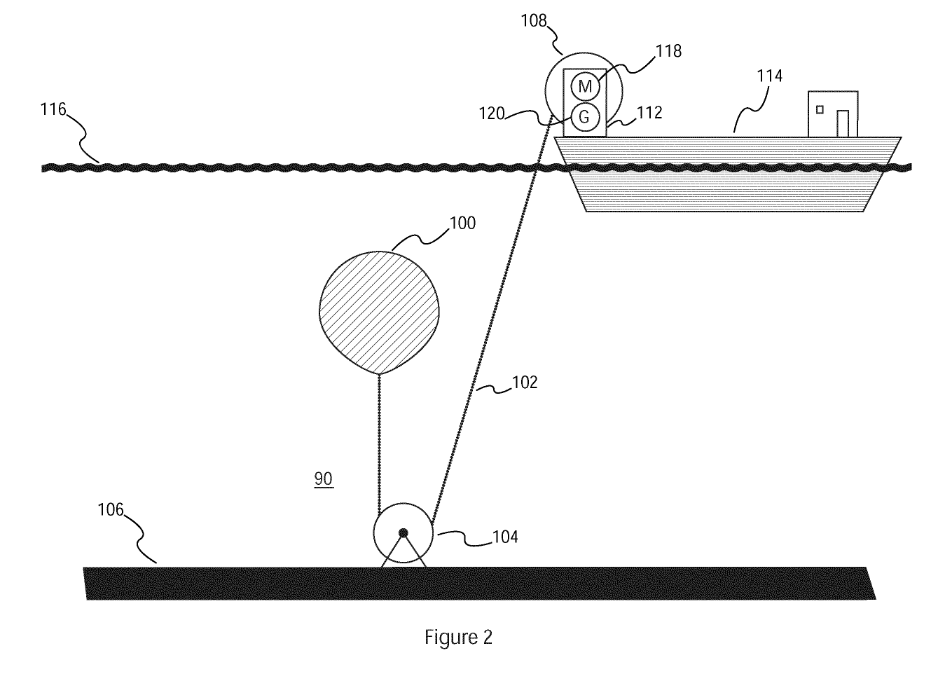

An embodiment of a water based buoyancy energy system 90 is shown in FIGS. 1 and 2. An air filled balloon 100 is connected by a tether 102 to a pulley 104 that is anchored firmly to the seabed 106. The system can be anchored to the bottom of any suitable body of water including, for example, a sea, a lake, river, or reservoir. Regardless of the body of water in which the system is deployed, the bottom of the body of water in question can be referred to as a seabed or seafloor without departing from the scope of the present invention. The tether 102 is connected to, and wound on, a reel 108 that is operationally connected, for example by a shaft 110, to a generator and motor system 112. Without departing from the scope of the present disclosure, the reel, generator and motor can be disposed on the seafloor or, as shown in FIGS. 1 and 2, the reel 108 and generator and motor system 112 can be out of the water, disposed on a floating barge 114, which can also be referred to as a floating structure, which floats on the surface 116 of the water. Alternatively, the reel 108 and the generator and motor system can also be disposed on the shore, which can also be referred to as the coast. The motor and generator system 112 can also be referred to as a motor-generator unit. There is a very significant cost advantage to having the reel and motor-generator unit (or a motor unit distinct from a generator unit) on land because this alleviates the need to do any maintenance to these more complex mechanical/electrical units underwater and furthermore eliminates the need to run electrical cables underwater. The advantage is that all the complex components of the system are on land where they are not exposed to corrosion due to being submerged and furthermore they are easily accessible for maintenance. The only parts of the system in the water are very simple and resistant to wear and tear, those being a balloon, a pulley, and a tether.

FIG. 2 shows the same system as FIG. 1 except that it is in a two-dimensional side view whereas FIG. 1 is in a perspective view. The motor and generator system 112 can be considered to be two functional components, an electric motor 118 and an electric generator 120, both shown in FIG. 2. In reality, these components can be one unit, or separate units, without departing from the scope of the present disclosure. The mechanical connection, or operational connection, between the reel and the motor and the reel and the generator can be made using a shaft, a chain, gears, or any other suitable connection commonly employed in machines.

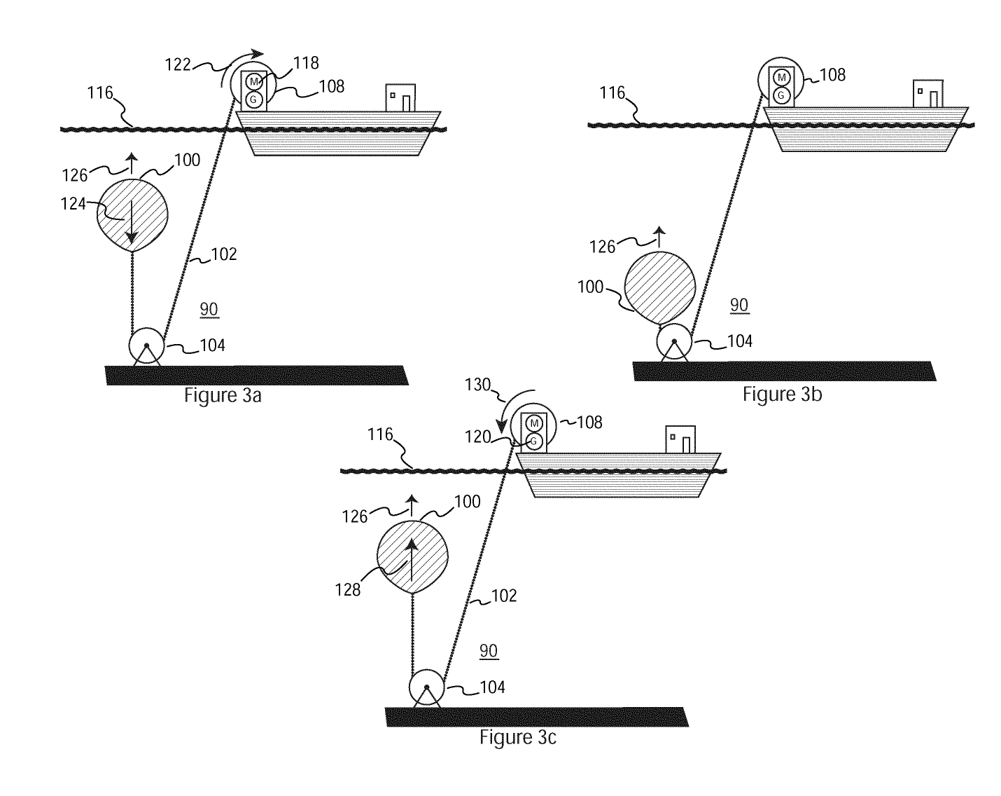

Operation of the system 90 is shown in FIGS. 3a-3c. In order to store energy in the system (charging), electricity is used to turn a motor 118 that turns the reel 108 in the direction indicated by the arrow 122 and pulls on the tether 102. The tether 102 pulls the balloon 100 in a downward direction, indicated by the arrow 124, against the buoyant force, indicated by the arrow 126. When the balloon 100 is pulled as far down as possible, as shown in FIG. 3b, down to the pulley 104, the system 90 is storing a maximum amount of energy. In order to extract energy from the system (discharging) as shown in FIG. 3c, the balloon 100 is allowed to rise as indicated by the arrow 128, pulling on the tether 102 and turning the reel 108 in the direction indicated by the arrow 130. This motion spins the generator 120, producing electricity. The electricity produced can be provided from the barge to an electrical grid through electrical cables (not shown) connecting the barge to the electrical grid (not shown).

In addition to storing electricity and producing electricity, the system 90 can also store and produce mechanical rotary force. Instead of, or in addition to electricity, combustion engines, hand cranks, wind turbines, or any other suitable mechanism can be used lower the balloon 100 in the water to charge the system 90, and the output energy (or power) of the system can be used mechanically as well. As such, the systems does not need to be used exclusively for electricity storage, but can be used for mechanical power storage as well. As will be understood by the skilled worker, the water in which the balloon 100 is submerged can be referred to as a fluid.

The amount of energy that can be stored by the exemplary system 90 is a product of the buoyant force times the working depth. The working depth is the range of depths over which the balloon can move. A balloon filled with pressurized air at 11 bars of absolute pressure with a diameter of 10 meters will be subject to a buoyant force of approximately 5,000,000 Newtons. If this balloon starts just below the surface of the water and is pulled down by a tether to a depth of 100 meters, then the amount of work required for this is approximately 500,000,000 Joules, not including the work required to overcome friction. This 500,000,000 Joules of energy can be recovered when the balloon is allowed to rise, spinning the reel and powering a generator.

The potential 500,000,000 Joules of stored energy in the system 90 is equal to roughly 139 kiloWatt-hours (kWh). Assuming a charging efficiency of 96%, the discharging efficiency of 94% and a round trip efficiency of 90%, then charging the system described above would require using 145 kWh and 130 kWh could be usefully recovered. 130 kWh is sufficient energy to power 5 typical households for 1 day. The energy storage system could be designed so that it would charge daily during periods of low energy demand (such as during the night) and provide energy during periods of peak demand. The charging and discharging time periods determine the size of the generator and the motor. If the example system described above can charge completely over a 6 hour period and discharge during a 3 hour period, then the motor power would be 145 kWh divided by 6 hours, equal to roughly 24 kW, and the generator size would be 130 kWh divided by 3 hours, equal to roughly 43 kW. The rate at which the balloon would move during the charging phase would be about 5 mm per second, and during discharging it would move at about 1 cm per second. These rates are slow enough that drag forces will have a negligible effect on performance.

There will be some losses due to inefficiencies in the motor, the generator, and friction in the pulleys, but over-all efficiencies of 90% are not unreasonable given the efficiencies of modern electric motors, generators, and low friction pulleys. A pulley can have around 99% efficiency, the motor can have around 97% efficiency, and the generator can operate at around 95% efficiency. The round trip efficiency of the system can be calculated by multiplying the efficiencies of each stage. During the charging phase the efficiency at transferring energy via the motor and pulley to the pull down the buoyant body would be the product of 99% and 97% equal to roughly 96%. During the discharging phase, the pulley and generator efficiency would also be equal to roughly 94%. The round trip efficiency is the product of the charging efficiency, 96%, and the discharging efficiency, 94%, equal to roughly 90%. If lower efficiency pulleys, motors or generators are employed the round trip efficiency will be reduced. Even if relatively low efficiency components are employed, a round trip efficiency of over 70% would be easily achieved and this level is sufficient for the purpose of usefully storing energy.

The tether 102 should, if possible, be extremely strong. A number of options exist, including nylon ropes or webbing, wire cables, chains, or carbon nano-tube based tethers. Any strong cable or tether material can be used. The tether is not intended to be very elastic, and should be stiff, but slightly elastic materials are acceptable as well.

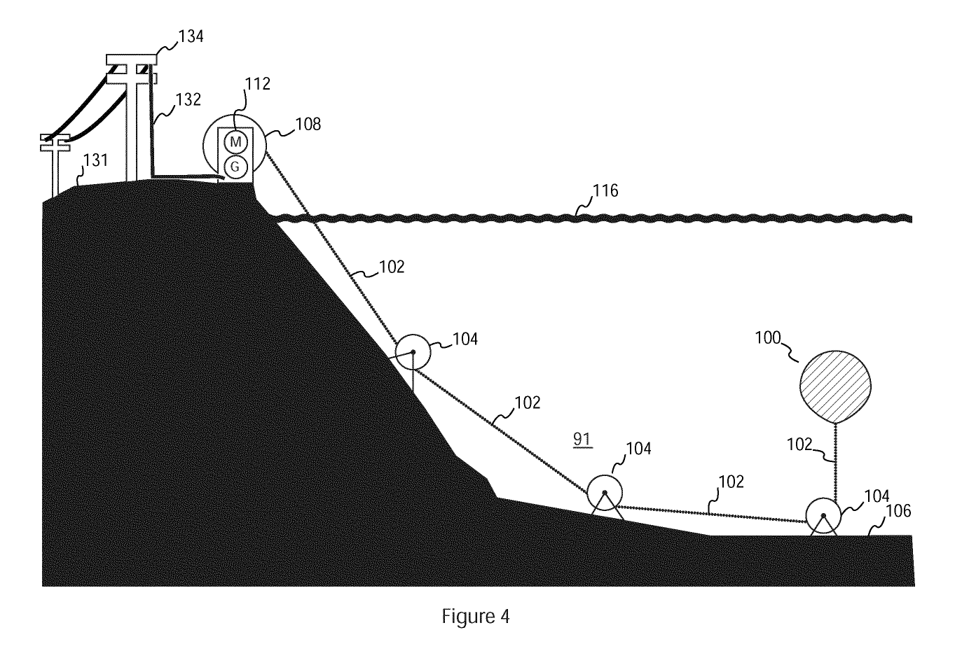

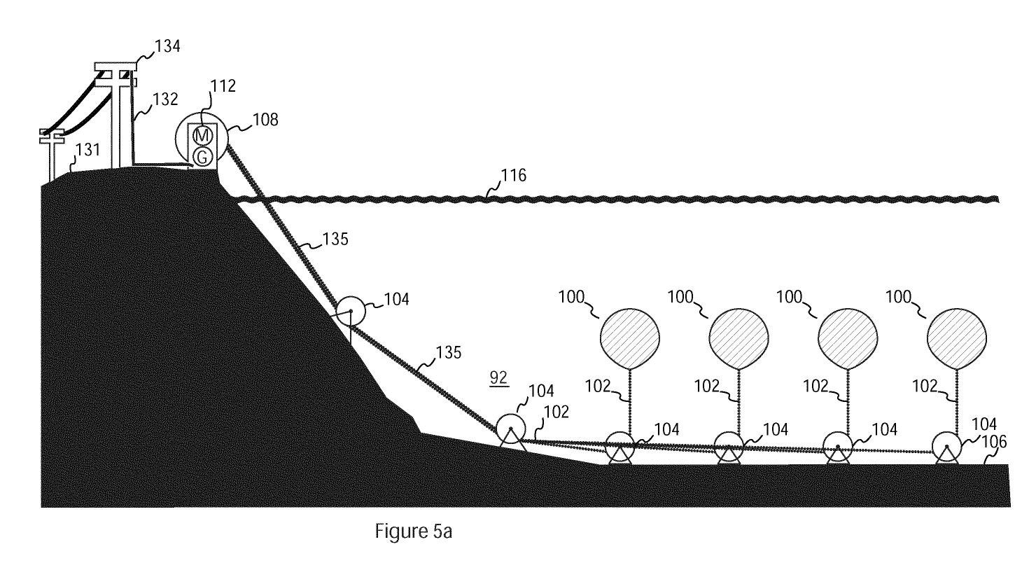

As shown in FIG. 4, in the energy storage system 91, rather than having the tether 102 connect the balloon 100 to the reel 108 and the motor and generator system 112 disposed on a barge, these may be positioned on land 131. Positioning the reel 108 and the motor and generator system 112 on a platform, or even on the sea-bed itself are also within the scope of the present disclosure. Also shown in the exemplary embodiment of FIG. 4, the tether 102 connects to the reel 108 on land via several pulleys 104, rather than just one pulley. This helps guide the tether 102 to the reel 108 while keeping it taut and near the bottom of the body of water. In practice, any number of pulleys could be used in connecting balloons to reels.

The advantage of locating the reel 108 and motor and generator system 112 on land 131 is it makes it simpler to connect the system electrically 132 to a land based power grid 134. It also makes installing and servicing the generator and motor system 112 much simpler, and eliminates the need for a barge. However, it might require more anchored pulleys in order to reach the shore with the tether, and a longer tether.

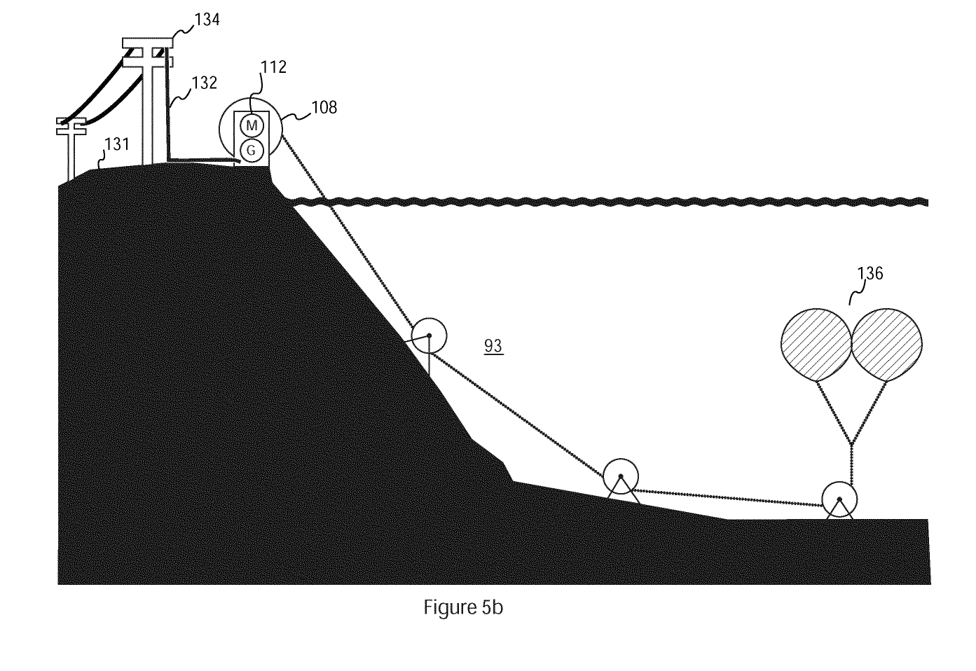

Another advantage of a land-based system, such as system 91 shown in FIG. 4, is that it can be much larger than a barge-based system, such as shown at FIGS. 1 and 2. The relatively small systems described thus far, with generation capacity of only 43 kW would be insufficient to have a real impact on the power needs of a city, province, state, or serious industrial facility. In fact, larger systems are more practical and small systems are being described here by way of example only. Larger systems can be built by arraying many balloons 100 over a large area of sea-bed and connecting all their tethers to one or more generators. This is shown in the example of FIG. 5a where an energy storage system 92 has multiple balloons 100, where each balloon 100 is connected to a tether 102, and the tethers 102 are bundled together into a group 135, which is connected to the generator and motor system 112 on shore. In this way a larger energy storage system can be built which would have a large storage capacity. If a system capable of storing 20 MegaWatt-hours (MWh) were desired, and if each balloon employed had the size operating depth described above (10 meter diameter, 100 meter depth), then roughly one hundred and forty separate balloons would be required. In principal, thousands of balloons could be arrayed in a large field on the sea bed in order to allow storage of any amount of energy. The generators could be three phase generators connected directly to the grid and the energy storage system could be used to provide grid stability.

Monitoring of grid demand can be used to control when to charge and when to discharge the energy storage system. In open energy markets where the cost of electricity fluctuates, a computer system could track power cost on the grid and begin charging the system when energy costs fell below a certain level and would begin discharging for the purpose of selling energy back to the grid when energy costs jumped above a certain level. The daily variations in price of electricity are generally relatively stable, but some real time tracking of price would allow for optimal operation of the energy storage system.

When multiple balloons 100 are employed, there can be three ways in which the multiple tethers 102 can connect to the generator and motor system 112. On the one hand, all the tethers can be simultaneously wound on a single reel so that all balloons rise and descend in unison effectively behaving as a single, massive buoyant body. Alternatively, each tether could connect to an independent reel, each of which could mechanically couple to separate motor and generator systems individually and therefore allow a system where each balloon can be independently lowered to store energy or allowed to rise to recover energy. Lastly, a combination of the two could be used whereby clusters of balloons 100 are tethered together to a single reel, and multiple clusters occupy distinct reels.

In the examples shown in above-described Figs., a single balloon 100 is shown attached to each tether 102. In reality, as shown in FIG. 5b, in an energy storage system 93, it is possible to use a cluster 136 of balloons 100, potentially all sharing a single tether 102. Any number of balloons 100 can share a tether 102, just as any number of tethers 102 can connect to a single balloon 100. The balloons 100 can be clustered, as shown at FIG. 5b, or arranged in series like beads on a string.

The pulley or pulleys 104 shown in the above exemplary systems need to be fixed or anchored to the seabed. The pulleys 104 will need to resist the buoyant force on the balloon as well as any forces caused by currents or waves on the balloon, so the anchoring of the pulleys should be strong. Forces on the pulleys 104 will not always be in a fixed direction, as water currents and tides can cause the forces on the pulley to change. The pulleys can be anchored by means of a concrete foundation or by piles or bolts driven directly into the seabed.

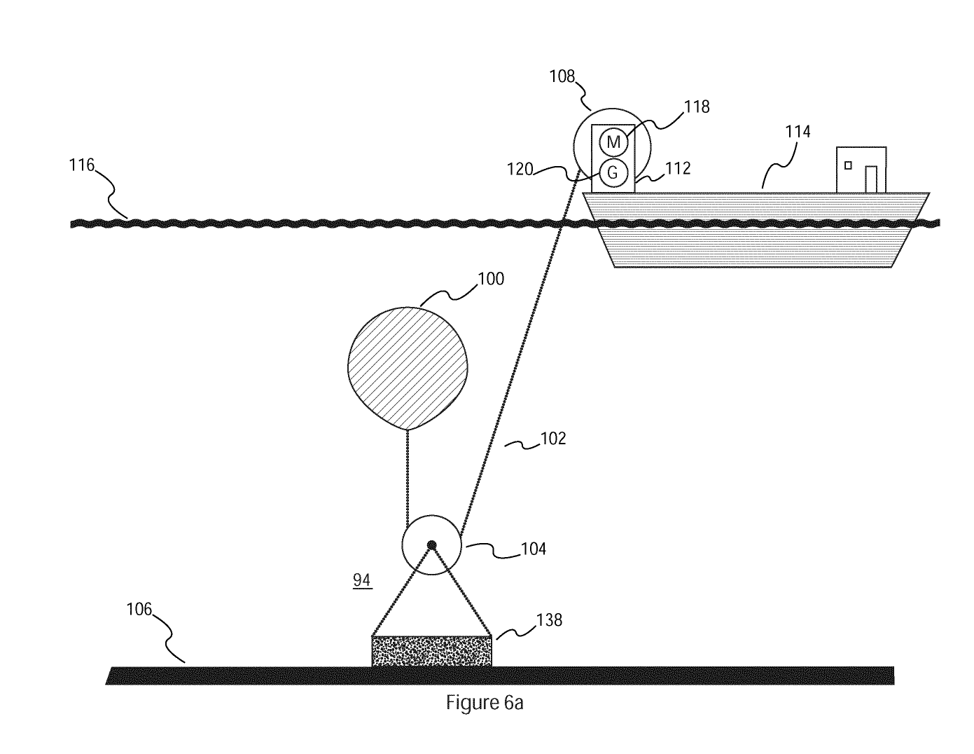

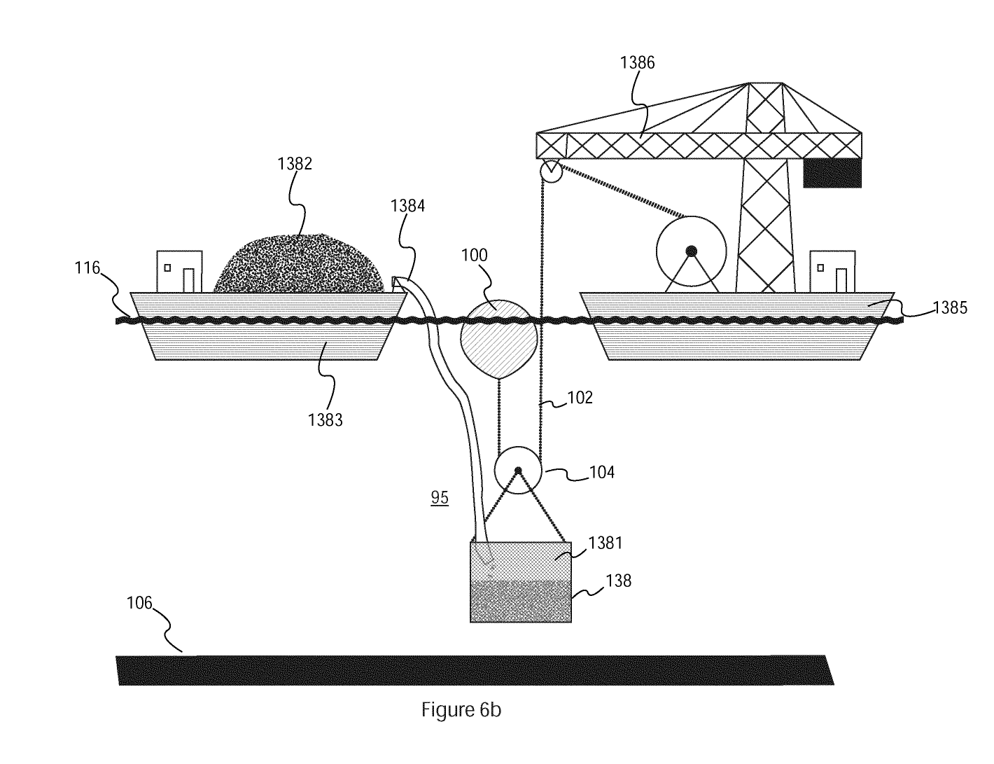

Another embodiment of the present disclosure is shown in FIG. 6a, where an energy storage system 94 has a massive ballast 138 that sits on the seabed 106 to hold the pulley 104 down. The mass of the ballast 138 would have to be large enough so that the force of gravity on the ballast 138 would offset the buoyant force on the balloon 100. If the ballast 138 were twice as dense as water, then ballast with a volume equal to the balloon volume would be just sufficient to keep the balloon from lifting the reel and ballast up off the sea-bed. In order to keep the system stationary under currents, the ballast would need to be larger. A large ballast with twice the density of water and over twice the mass of the water displaced by the balloon would work well. As described below, ballast could be provided by way of a ballast sack that would be filled with earth or rocks.

FIG. 6b shows a an energy storage system 95 with means to produce a ballast in a cost effective way. A ballast sack 1381 can be attached to the pulley 104 which could then be filled with earth or another ballast 1382 during installation of the balloon at sea to create a ballast 138. A barge 1383 carrying ballast could employ a chute 1384 to fill the sack 1381 with ballast. A second barge 1385 could use a crane 1386 to control the descent of the ballast 138.

In the above-described exemplary systems, as the balloon 100 is lowered to deeper depths or as it rises to shallower depths it will be subject to changes in pressures and temperature. The air in the balloon can be treated as an ideal gas, governed by the equation: PV=nRT where P is the absolute pressure of the gas, V is the volume of the gas, n is the number of moles of gas, R is the universal gas constant, and T is the absolute temperature.

In water, there is an approximate relationship of 1 bar of pressure per 10 meters of water head, so if a balloon at the surface (i.e., 1 atmosphere of absolute pressure or roughly one bar) is pulled down 90 meters, then the absolute pressure on the balloon is increased by about 1000% to 10 bar. Ocean water typically ranges temperature ranges between around 300 Kelvins and 277 Kelvins, a variability of only about 7%. The number of gas molecules inside the balloon is constant because air cannot escape or enter the balloon, and R is constant. Because the change in temperature is relatively small, temperature variations can be largely ignored with air filled balloon in water (this is not the case with hydrogen filled balloons in air, which are described further below). As such, the equation simplifies to PV=Constant so that any change in pressure results in a proportionate change in volume.

If the pressure in the balloon is 1 atmosphere absolute pressure when the balloon is at the surface, then when the balloon is lowered by 90 meters the balloon will be subject to 10 bars of absolute pressure, and the balloon will necessarily shrink to one tenth its initial volume. This will reduce the buoyant force on the balloon 100, since the balloon is displacing less water.

In order to avoid this shrinking volume issue, the balloon 100 can be pressurized so that its internal absolute pressure matches, or exceeds, the absolute pressure at the deepest depth at which it will be lowered. If the balloon is to be lowered to 100 meters, then the air inside the balloon should be at an absolute pressure of at least 11 bars. When such a balloon with 11 bar absolute internal pressure is at 100 meters depth, the internal pressure and the surrounding pressure will be substantially equal and the skin of the balloon 100 will not be subject to any significant force due to pressure differentials. However, when this same balloon is at the surface of the water, there will be a 10 bar pressure difference between the inside of the balloon and the environment outside. The balloon skin can be made stiff enough to resist expansion or damage at these high pressure differentials, and the balloon skin will be under tension when the balloon is at the surface. However, the balloon will not change appreciably in volume over the range of depths between the surface and 100 meters. This will result in a substantially constant buoyant force over those depths as well. As will be understood by the skilled worker, the maximum operating depth determines the required pressurization of the balloon 100.

For the submerged air filled balloons 100, the balloon skin needs to withstand large pressures. As sated above, the balloon 100 can be pressurized so that it does not shrink in volume at depth, so the pressure inside the balloon will be at least equal to the surrounding water pressure when the balloon is at the bottom of its operating range.

When the balloon is at the surface of the water, the surrounding water and air has a pressure of one atmosphere or approximately 1 bar. If the balloon is designed to operate at depths where the absolute pressure is 21 bars (200 meters underwater) then the relative pressure between the inside of the balloon and the environment will be 20 bars. This means that the balloon's skin must resist a force of 200 Newtons per centimeter squared.

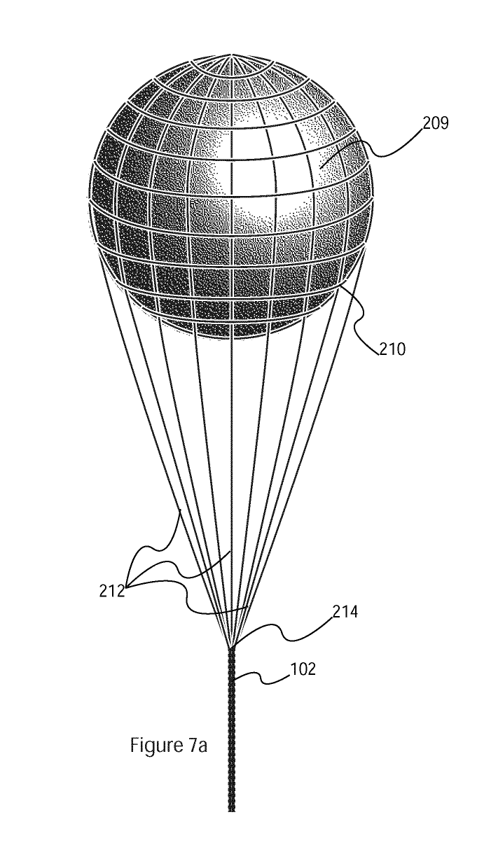

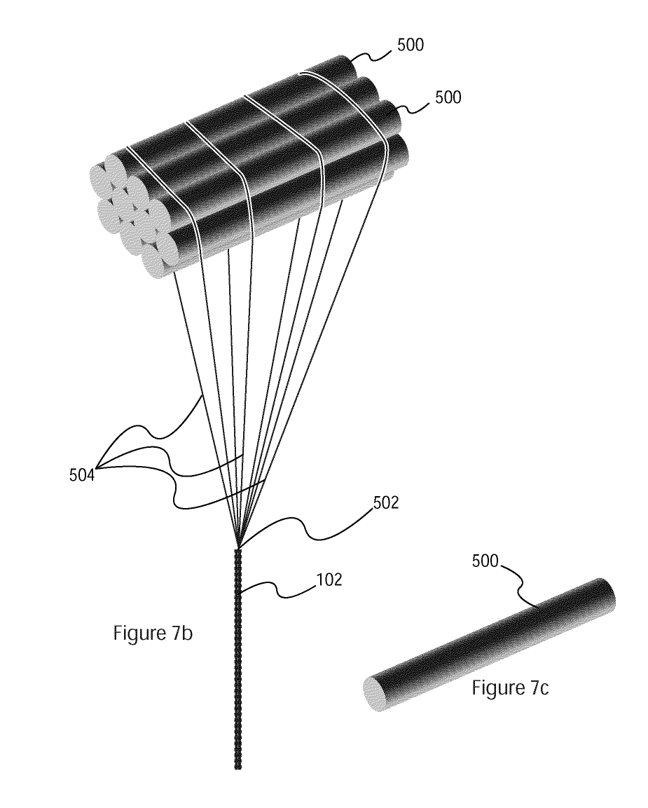

As shown in FIG. 7a, an air-filled balloon 209 can be made substantially spherical in order to accommodate these high forces. A spherical balloon will avoid point weaknesses, as all the material will be strained by the same amount. To avoid compromising the integrity of the balloon's skin, the tether 102 can be attached to the balloon via a mesh net 210. The mesh net can be made out of steel cabling, or some other cable material such as nylon, and will protect the balloon skin from point strain that could lead to rupture. The net would extend a series of cables 212 which would merge with the tether at a strong junction 214. This structure is a good balloon structure for embodiments of submerged systems described in the present disclosure.

Another way to create a buoyant body (or buoyant object) that can resist the pressure at depth is to make it stiff-walled. A buoyant object could be made in a cost effective manner by employing plastic or metal pipes capped at both ends and employed either individually or in clusters. Plastic pipes made of acrylonitrile butadiene styrene (ABS), polyvinyl chloride (PVC), polypropylene (PP), polyethylene (PE), polyvinylidene fluoride (PVDF) or polybutylene (PB) could all be employed to create buoyant bodies that could replace balloons in any of the submerged balloon energy storage systems described in the present disclosure. Capped sections of pipe would weigh more than a thin membrane balloon but would not require pressurization and would be robust. A buoyant body made using stiff walled pipe sections with caps, or another pressure vessel, can be used in place of a balloon 100 in any of the submerged balloon energy storage systems described in present disclosure, and the word balloon 100 can be taken to refer to either a balloon or any other suitable buoyant body or object.

FIG. 7b shows an alternative embodiment to the balloon 209 of FIG. 7a. In FIG. 7b, the balloon has been replaced by a series of stiff-walled hollow pipe sections 500 connected to the tether 102 at a point 502 by cables (504). Any number of pipe sections can be used. FIG. 7c show an individual section of hollow pipe 500. The hollow pipes are sealed at each end to prevent water from entering therein.

The balloon, or balloon skin, can be made out of a variety of materials. The buoyant object can be a typical pressure vessel such as a steel cylinder; however, this is likely to be expensive. More likely materials are polymers and composites, which are pliable but stiff and strong. Urethane coated nylon woven fabric would be a good candidate material. The seams would need to be very strong in order to resist the pressures involved. The balloon material can be treated using a process to inhibit diffusion of air or water through the skin of the balloon. For example, the balloon polymer can be aluminized to inhibit diffusion or air or water through the balloon or balloon skin.

Generally, in contexts such as factories, propane filling stations, and in homes, pressurized vessels must be extremely strong for safety reasons. However, for pressurized air filled balloons in the water, there is very little safety concern since the explosion of a balloon would result simply in a brief frothing at the surface of the water and a sinking of the balloon and tether. As a result, the system can be designed to be only as strong as necessary, with a small factor of safety. As far as safety considerations are concerned, workers would have to be shielded from potential rupture of a pressurized balloon. This could be done by pressurizing the balloons only after completing installation of the whole system and immediately prior to pulling the balloon under water, and a remote operated release valve could be part of the system in order to allow bleeding off of pressure before any maintenance.

Maintaining the balloon 100 at a constant volume has the advantage that the buoyant force on the balloon 100 will be constant as well. This is advantageous because if the force is constant then the rate at which the reel 108 winds and unwinds can be constant as well. This eliminates the need for multiple gears, as both the motor and the generator can be designed to operate at a single speed. This simplicity will substantially reduce overall system costs.

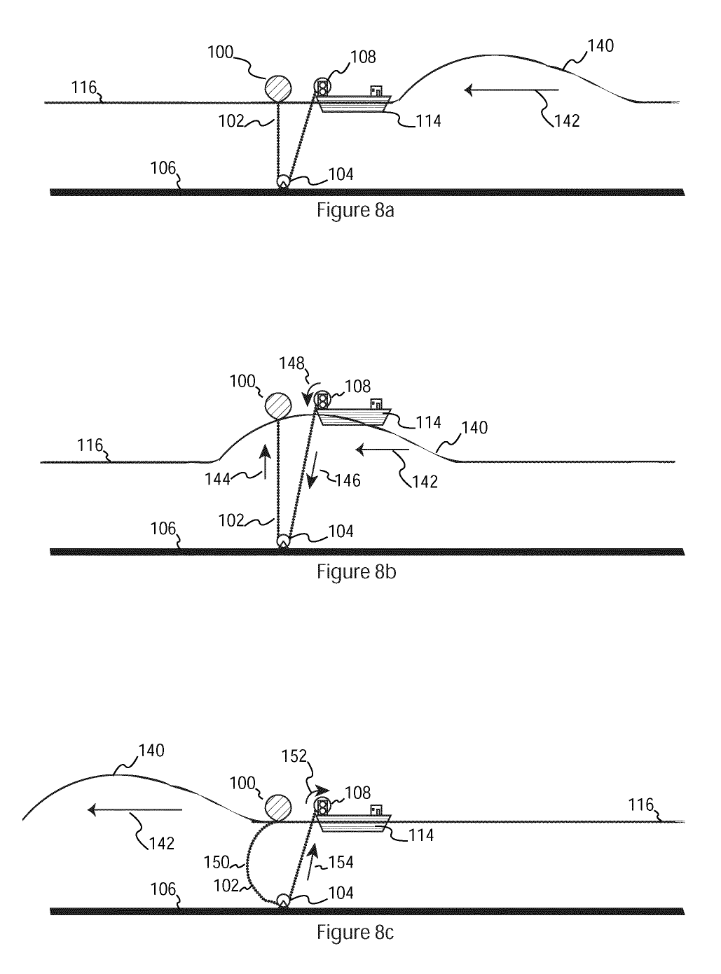

Waves can be used in conjunction with a variant of the above-described exemplary systems to generate power. Work can be done by a passing wave on the system to generate power. Such a system would function as shown in FIGS. 8a-8c. In this implementation, the balloon 100 is not fully submerged, and the internal pressure in the balloon can be atmospheric, as it does not need to be submerged. However, a system designed for energy storage can be used in the way described here in order to generate electricity without altering the systems described above by raising the balloon up to the surface of the water.

A balloon 100 would sit at or near the surface of the water 116, and be connected via a pulley 104 (or several pulleys) on the seabed 106 to a reel 108 located on a barge 114 floating on the water surface 116. An incoming wave 140 traveling in the direction indicated by the arrow 142 is shown in FIG. 8a. When the wave 140 arrives at the site of the system, it lifts the balloon 100 and the barge 114 (FIG. 8b), the tether 102 is extended in the directions indicated by arrows 144 and 146. This causes the reel 108 to spin in the direction indicated by the arrow 148. As before, this spinning can be used to drive an electrical generator located on the barge 114.

After the wave 140 has passed (FIG. 8c), the barge 114 and balloon 100 drop and there is slack 150 in the tether 102. This slack 150 is taken up by the reel 108 by turning it in the direction indicated by the arrow 152 and pulling the tether in the direction indicated by the arrow 154. Taking up the slack 150 with the reel 108 is done by a motor, not shown. The amount of work required to take up the slack is only the work required to overcome friction in the system, because the balloon 100 is not being pulled underwater. Therefore, there is a net gain of energy; more energy is captured from the passing wave than is required to reset the system to its initial state after the wave has passed.

The tension in the tether can be monitored continuously (or intermittently) in order to determine when to reel in the balloon and when to let the balloon out. When the wave passes, the balloon is pulled up and there is a momentary increase in force that will cause the mechanism to begin reeling out the tether, turning the generator. Once the wave passes, the slack line will have less tension in it and this will signal the motor to begin turning to reel in the tether 102. As stated above in relation to the exemplary embodiment of FIGS. 3a-3c, electrical cables can connect the barge 114 to a power grid,

This energy can be used to generate electricity that can then be sold to the grid or used for any purpose, as with any other energy generator.

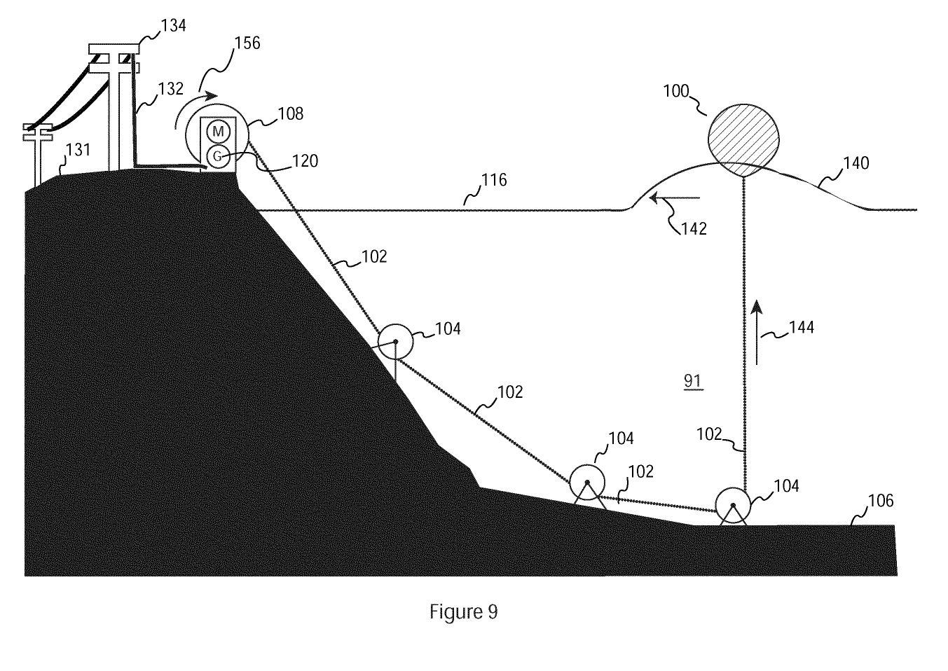

Another embodiment of the present disclosure is shown at FIG. 9. At FIG. 9, the reel and motor and generator system 112 are placed on land 131. The balloon 100 is lifted by an incoming wave 140 moving in the direction shown by the arrow 142. This pulls on the tether 102 in the direction indicated by the arrow 144. The tether is connected to the reel 108 on land 131 by a series of pulleys 104 anchored to the seabed 106. The pull on the tether 102 causes the reel 108 to spin in the direction indicated by the arrow 156. This causes the generator 120 to spin, making electricity. When the wave has passed (not shown), the slack in the tether is taken up by a motor. The motor does less work than the electricity generated by capturing energy from the passing wave, so there is a net positive amount of energy generated by the system as with the system shown in FIGS. 8a-8c.

Other variants on the system would include placing the balloon either partially or entirely beneath the surface of water. Using a floating buoy or even a boat, which is also a buoyant object, rather than a balloon is another option. Furthermore, the force supplied by the wave to spin the reel can be used for things other than generating electricity. For example, the spinning motion can be used to spin a pump for reverse osmosis desalinization, or for any other mechanical action.

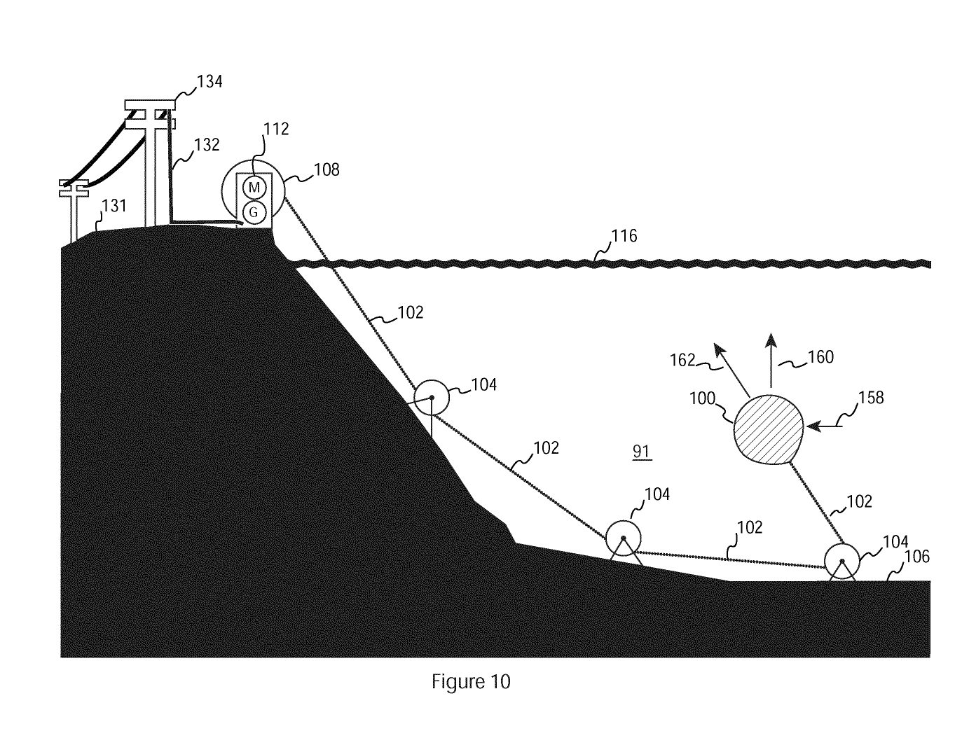

Ocean currents, or currents in a lake or reservoir, can be used advantageously in order to make energy storage systems of the present disclosure more effective. The simplest example to consider would be a constant current. This is shown in FIG. 10. A constant current will create a lateral force 158 on the balloon that will add to the upwards-buoyant force 160 on the balloon. The sum of the forces 162 on the balloon 100 will tilt the tether 102 off to one side, depending on the direction of the incoming current.

If the current is constant, then its effect is equivalent to increasing the buoyant force on the balloon 100. Thus, if a 10 meter diameter balloon was subject to a buoyant force of 5,000,000 Newtons, and the current exerted a force of 1,000,000 Newtons in a direction perpendicular to the buoyant force, then the net force would be 5,100,000 Newtons using vector addition. If the tether has a working range of 100 meters, then the addition of the current increases the energy storage capacity of the system from 500,000,000 Joules to 510,000,000 Joules. Currents can also have a larger affect on the force, and the force due to currents can be larger than the buoyant force in some cases.

If the current is variable then it can lead to inefficiencies if not controlled properly. For example, if the balloon is reeled in during a period of high current, then the motor will have to do extra work to overcome this current. If the balloon if reeled out during a period of low or no current, then the generator will generate less electricity than if the current were present and increasing the pull on the balloon, and therefore the force available for generation.

However, if the system is reeled in when currents are low, and reeled out when currents are high, then a net power gain is possible and the system can generate electricity. In a system used primarily for power storage, deciding when to charge and discharge the system should be done with consideration to the currents at the time in order to maximize efficiency. Flow sensors, velocimetres or tidal data could be used to help the system that is monitoring the grid decide when to charge and discharge the system. This data would be used in conjunction with whatever power grid demand monitoring that was being used. For example, if the system typically only begins charging when energy prices drops below 4 cents per kWh might begin charging when energy prices were higher than this, say 5 cents per kWh if the current conditions were favorable.

If the system is installed in a location with reliable currents, such as tidal currents, then it can be used to effectively generate electricity. The system would be reeled out whenever currents are strong, pulling on the balloon and generating electricity, and reeled in when currents are weak. A net positive amount of energy can be generated, with work being done by the currents. The amount of energy that can be produced depends the force imparted from the water current to the balloon and how much the current varies. The force due to current on a balloon will vary as the drag force, which is proportional to the velocity of the water current squared.

In all cases, the maximum current must be considered when selecting tether strength, and the strength of the anchoring mechanism for the pulleys or the weight of the ballast for pulleys.

Very large systems, employing many balloons and tethers are likely to be the most common implementations of this technology, as it is being developed as a grid connected large-scale storage system.

The motors and generators are likely to be one of the most costly components of this system, and as such it might be desirable to have systems where a number of balloon, tethers, and reels can all couple to a smaller number of motors and generators. For example, three reels could couple, one at a time, to a single motor. The motor could wind up each reel in sequence, decoupling from a reel once the balloon was pulled all the way down and the maximum power storage of that portion of the system was reached. The reels could also couple to a single generator, one at a time.

Alternately, many balloons and independent reels could be mechanically coupled simultaneously to a single set of motors and generators. The generators and motors would need to be scaled to match the power requirements to bring the balloons down and to generate power as they all rise up. A 100 MW generator/motor system, or a motor/generator system of any other suitable power could be connected to many balloons in this way.

The balloons do not have to be 100% air and water tight, some small degree of diffusion of air or water through the skin of the balloons is permissible provided that it is a slow process. The balloons could be fitted with valves so that, from time to time, they can be lifted to the surface and a servicing boat with an onboard pump can restore the necessary air pressure to the balloons and remove any condensation from within the balloons. If material choice is made correctly, then this topping up and inspection step can be occasional, only once every few years.

If a submerged buoyant power storage system is used to store power generated by wind power, particularly by offshore or near shore wind, then the reel of the storage system can be mechanically coupled directly to the generator of the wind turbine. This works because the reel provides rotary motion for a generator when the balloon is allowed to rise, and this rotary motion can be used to spin the generator that the turbine normally spins. The mechanical connection can be made using chains, shafts, gears, or any other rotary mechanical connection. By using the generator inside the turbine in this way, costs can be reduced on the storage system because the same generators are used for generation from wind energy, as well as for generation during discharging of the storage system.

The rotary motion of the wind turbines can also be used to directly wind the reel, charging the storage system. This eliminates the need to have a motor from the storage system and can further reduce cost and potentially increase efficiency.

Wind power and submerged buoyancy based energy storage are a good combination, because wind power is often located off shore or near shore, and the storage can enable the wind power system to provide power when it is needed rather than only when it is windy. Areas with high wind power deployment are often oversupplied on windy days and this excess power capacity is often wasted The wind turbine can be used to directly mechanically actuate the reel, but it is more likely that the electricity generated by the wind turbines will be employed to actuate the reels of the storage system.

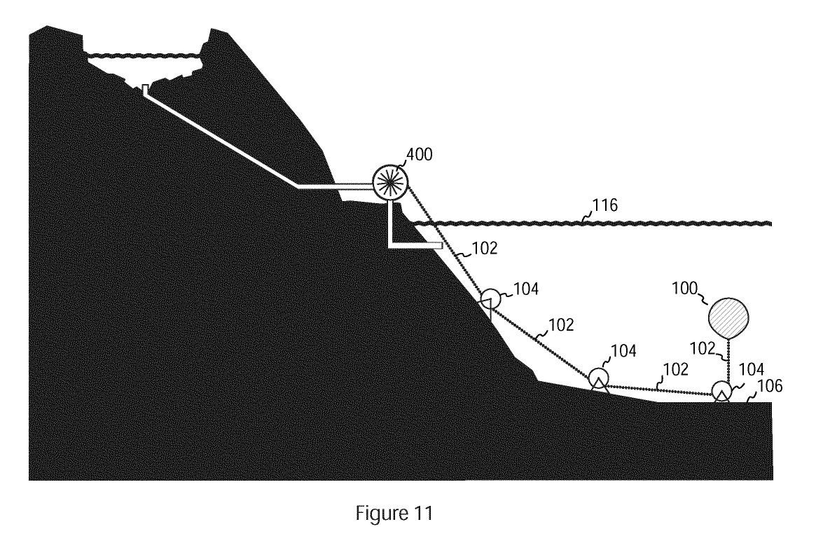

The buoyant power storage systems can be coupled mechanically to hydro power systems, nuclear power systems, or to any power system where rotary motion is used to spin a generator and make electricity. This allows the system to share the same electrical generator and alleviates the need for a motor, but requires a mechanical connection to the electrical generation system be made. FIG. 11 shows an example with a hydropower turbine that has a mechanical connection to the reel of a submerged energy storage system. The hydropower turbine 400 is shown overlaid where the reel, motor, and generator for the buoyant energy storage system is located. The hydro power can be used to directly reel in the balloon 100 for energy storage, or the balloon 100 can directly spin the generators in the absence of hydro water flowing through the generators.

Polymers can have high rates of diffusion across their membranes. Submerged systems must be designed to inhibit diffusion through the skin of air from inside of the balloon into the surrounding water, and water from outside of the balloon into the inside. Aerial systems, such as described below, will need to be designed so that hydrogen (or helium) inside the balloons does not diffuse out through the skin or does so at an acceptable slow rate.

Weather balloons, which contain hydrogen, are aluminized to make them less permeable to hydrogen so that they remain inflated longer. This process is one where the polymer is coated in a thin layer of aluminum. This same process can be employed for both submerged and aerial power storage systems. The aluminum coating is thin enough that it does not inhibit flexibility of the skin of the balloon, but it does significantly reduce diffusion through the balloon skin. Other suitable metallization coatings or diffusion inhibitors can also be employed.

Other coatings and materials can also be employed to inhibit diffusion through the balloon skin for aerial and submerged systems.

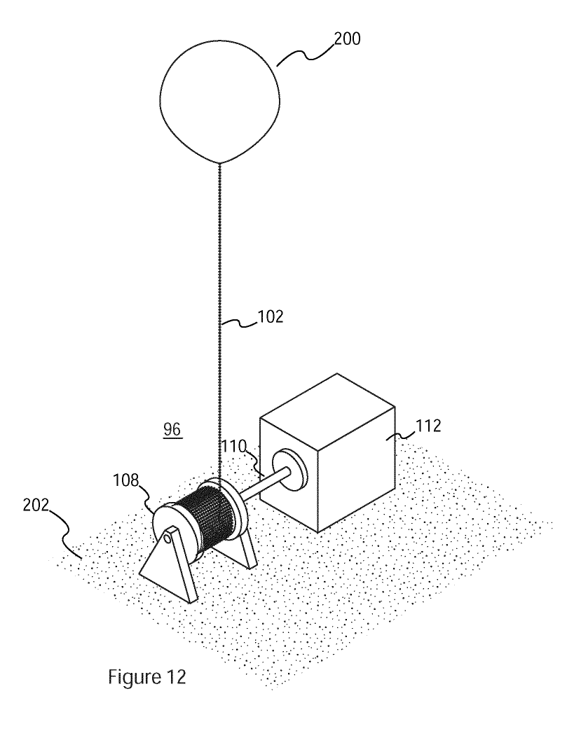

An embodiment of an aerial based buoyancy energy storage system is shown in FIG. 12 at reference numeral 96. A lighter than air balloon 200, such as a helium filled balloon or a hydrogen filled balloon, is connected by a tether 102 to a reel 108 anchored to the ground 202. The reel 108 is connected mechanically, for example by a shaft 110 to a generator and motor system 112.

The balloon is subject to a buoyant force equal to the force of gravity on the balloon plus the tether minus the force of gravity on the air it displaces. For the sake of example, consider a spherical balloon with a radius of 10 meters filled with hydrogen. This would give it a volume of 4/3π10³ or approximately 4190 meters cubed, or 4,190,000 liters, and a surface area of 1260 meters squared. At sea level and 0° Celcius, air has a density of approximately 1.29 grams per liter and hydrogen has a density of approximately 0.090 grams per liter. Assume that the tether on the system weighs 0.1 kilogram per meter of length and that the balloon, including skin and other structural components, has a mass of 0.1 kilograms per square meter, or 126 kilograms in total. Assume that the tether is 1000 meters long and so it has a mass of 100 kilograms.

The mass of the hydrogen balloon including the tether and its skin is 602 kilograms, and it displaces a mass of 5412 kilograms of air. The gravitational acceleration at sea level is approximately equal to 9.8 Newtons per kilogram. Therefore, gravity exerts a force of 5900 Newtons on the hydrogen balloon and a force of 53,000 Newtons on the displaced air. There is a net buoyant force of 47,000 Newtons. With a maximum tether length of 1000 meters, the maximum power storage potential of this example would be 40,000,000 Joules. This value is quite low in terms of commercial energy needs, but might be high enough for locations where remote stable sources of energy are required.

It should be noted that for the same tether length and balloon diameter, submerged air filled balloon based systems can store almost 900 times more energy than systems based in the air. This is because the buoyant force in water is much greater than in air, owing to air's low density compared to water. However, land based systems using lighter than air balloons have some advantages in that they do not need to be close to water and they do not require pulleys since the reel can be connected directly to the vertical tether.

Wind plays the same role in an aerial balloon based system as water currents plays in a submerged system. A constant wind will increase the net force on the balloon and thereby increase the power storage capacity for a given tether length. Variable wind can either increase or decrease system efficiency, and can be used to generate power if the system is reeled out (discharged) when winds are high and reeled in when winds are low (charged).

If the system is operated at extreme heights, above 1000 meters, prevailing winds will dominate in terms of force over the buoyant force. The balloon design can be altered to catch more wind and increase forces further. This can potentially increase the energy storage capacity of ground based systems to the point of being viable.

A variation on the aerial system of interest is a solar power generation system. In such a system, the balloon is pliant and not necessarily spherical when the contents are at one atmosphere. It can increase in volume if the hydrogen gas inside the balloon heats up, causing it to expand and take on a spherical shape. The skin of the balloon can be designed to absorb as much solar radiation as possible. A double walled balloon skin, which had a clear exterior wall and a black interior wall with a gas filled section in between the two membranes would be an appropriate design, as the sunlight would pass through the clear outer wall and be absorbed by the black inner wall, which would in turn heat up the hydrogen (or helium) inside the balloon, The gas filled cavity would act as a of insulating layer which would slow heat escape into the surrounding air.

The ideal gas law is: PV=nRT where P is the absolute pressure of the gas, V is the volume of the gas, n is the number of moles of gas, R is the universal gas constant, and T is the absolute temperature.

Because the balloon is sealed, n remains constant. If the balloon is pliable as described, then the internal pressure will equilibrate to the external pressure of 1 atmosphere. This decreases as the balloon rises, but the change in atmospheric pressure is not significant over a range of a few thousand meters. Therefore, P can be treated as constant as well. This creates the proportionality: V=AT where A is equal to the constant term nR/P.

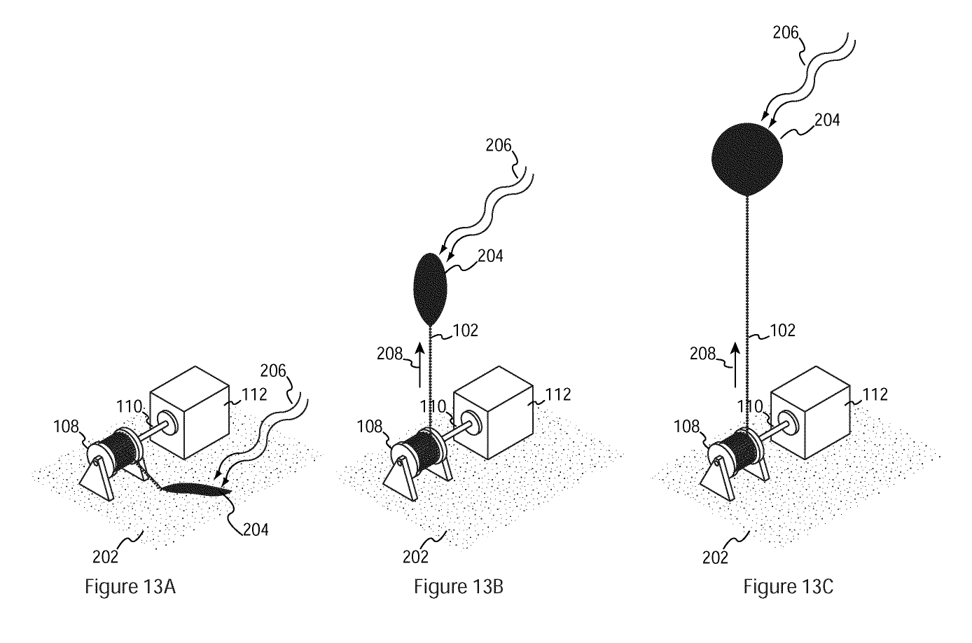

FIGS. 13A-13C shows an exemplary implementation of this system. For example, in the morning, the balloon 204 is sitting on the ground 202. The balloon 204 in FIG. 13a has an initial volume and is negatively buoyant, that is, it does not float in the air. As it absorbs solar radiation 206, the hydrogen inside the balloon heats up, expanding the balloon 204 to an expanded volume that gives the balloon 204 a positive buoyancy (the balloon can float in air), as shown at FIG. 13B. This creates a buoyant force and causes the balloon 204 to rise, pulling the tether 102 in the direction shown by arrow 208 and turning the reel 108 mechanically coupled to a generator. The hotter the balloon 204 becomes, the larger its volume and therefore the larger the buoyant force on the balloon 204. The balloon will have a maximum volume, when the skin of the balloon is taut and the balloon is spherical, as shown in FIG. 13C. Once the maximum volume is reached the balloon will continue to rise, constantly generating electricity by spinning the generator. The pressure inside the balloon will begin to rise above 1 atmosphere once the maximum volume of the balloon is reached if the balloon continues to heat up. As the sun sets, the balloon will still continue to rise and produce power as it cools off and contracts. At night, the balloon will cool off and shrink enough that it will fall back to the ground slowly, with the slack being reeled in by a motor using a minimal amount of energy. The slack can be detected with a simple tension sensor, or by using a clock and winding the device in on a controlled schedule.

The tether length used in such a system would be designed so that it could accommodate the maximum height that the balloon could reach in its rise on the longest, sunniest day of the year.

The balloon is designed so that it efficiently absorbs solar radiation and retains heat, but sheds enough heat to drop during the evening. This system could be very economical compared to photovoltaic-based solar power systems

To make the solar powered balloon based systems produce more power one could employ a double walled balloon. The external wall would be clear and would allow sunlight to shine through into the interior black absorbing balloon. The balloon would inflate and the clear external wall would create a greenhouse like effect, insulating the inner balloon against heat loss and increasing the sunlight absorption efficiency.

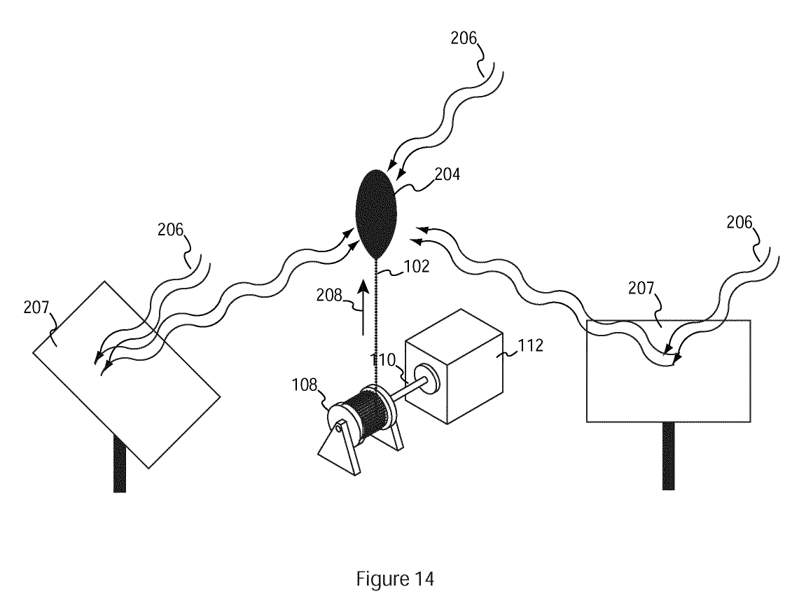

Ground based mirrors could be used to increase the solar radiation on the balloon in order to make the system more effective. The mirrors could either be stationary or they could follow the sun and aim light at the balloon. Shown in FIG. 14, this exemplary system would be similar to power tower based solar energy systems where heliostat mirrors 207 reflect sunlight 206 onto a central receiver, the balloon 204.

To make the system completely leak proof is likely to be difficult, especially because hydrogen atoms can diffuse through most materials. The system should, as much as possible, be made leak resistant, and require only occasional top ups of hydrogen to maintain functionality.

Energy storage can be used in order to enable power stations of any kind to deliver more power when it is needed while banking power when demand is low. Certain types of power stations, such as nuclear power plants, can produce a constant output, but demand is not constant. Power storage can be employed to offset the delivery of power to periods of the day when demand is higher. In many regulatory regimes, the price of power depends on the demand, so an energy generator could make more money by storing power when it is cheap and waiting until it is expensive to sell power.

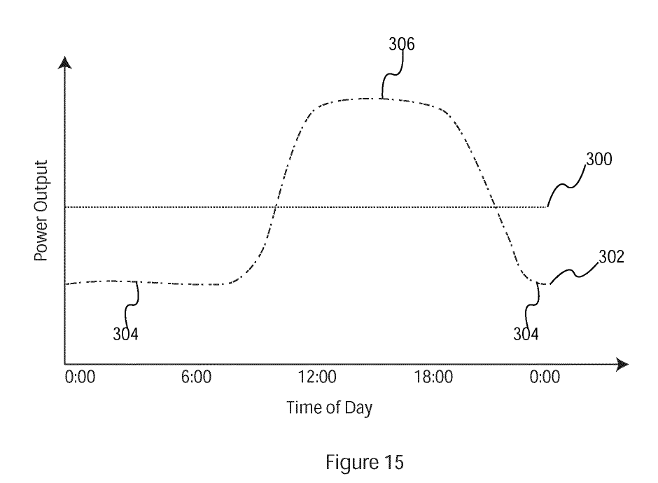

FIG. 15 is an exemplary plot of power output from a power generation system plus storage that shows an example of how power shifting works. The dotted line 300 is the output of a constant electricity producer such as a nuclear power plant, the dash-dotted line 302 is the output of a power load shifted system which has been optimized to deliver more power when it is required (i.e. during the day, particularly the afternoon). The system charges a storage system during the periods marked 304 and delivers peak power during the period marked 306. The peak power is delivered by running the discharging the storage system to increase the normal output of the generator.

It is possible to generate net revenue by buying electricity when demand is low, such as at night, and selling it when demand is high. If a storage system has a capacity of 1000 kilowatt-hours and if it charges once a day when demand is low and discharges once a day when demand is high, with a round trip efficiency of 90%, then the potential daily revenue generated by operating the system equals to, in an exemplary situation where power costs 10 cents per kilowatt-hour at night when demand is low, and 15 cents per kilowatt-hour during the day when demand is high: ($0.15−$0.10)*1000 kWh*90%=$45.

Actual systems would likely have storage capacities of hundreds of megawatts, rather than only a few kilowatts. Larger systems would employ many buoyant bodies in a large array, occupying a large area on the seabed. The above-described small system was used as an example.

In the present disclosure, motors and generators have, in certain examples been treated as separate units. Motors to wind a reel to charge an associated power storage system, and generators to produce power from the turning of the reel when discharging the power storage system have been discussed. In fact, a electrical motor and an electrical generator can be considered as the same thing, a generator will produce current if it is forced to spin, and a motor will spin if power is supplied. As such, while it is certainly possible that the motor and the generator would be separate units, each mechanically coupled to the reel, it is also possible that a single motor/generator system (motor-generator unit) would be built where a single set of magnets, windings of wire, and bearings, and would be able to act either as a generator or as a motor depending on weather the system is charging or discharging. This could lower cost and simplify maintenance, and would alleviate the need to couple and uncouple the motor or generator to the reel, as a single shaft from the motor/generator would be coupled to the reel at all times.

Additionally, either the motor or the generator, or a combined unit, could be built directly into the reel with no shaft or rod required for mechanical coupling. Single or multiple speed gearboxes can always be employed to match the rotational speed of the reel to the speed of the motor and/or generator.

When supplying power to the grid, it is important that the AC power be in phase with the grid and at the correct voltage. In most examples described above, the reel can be envisioned to spin at a constant rate. This would permit gearing to spin an AC generator at a constant rate as well, and make matching the phase and voltage of the delivered power to the grid's requirements trivial. However, a difficulty can arise if the reel needs to spin at variable rates. This can happen if currents are unpredictable in submerged systems, or due to wind gusts in aerial systems. It is possible to add a gearbox between the reel and the generator to compensate for the changes in rate of spin of the reel.

Alternatively, the reel can be connected directly to an AC power generator which would not be phase matched to the grid. The power from this generator could vary in voltage depending on the speed of the reel and it would be rectified into variable voltage DC power. This DC power would then be fed into an inverter which is grid tied. Inverters can track the grid phase and voltage and deliver appropriate current over a range of input voltages. The advantage of this system is that the grid matching is done using solid-state electronics, rather than gearing. This is a lower maintenance solution. Rectifiers and inverters are commonly available systems that are well known, with costs of generally 10-15 United States cents per watt and efficiencies of around 95%.

The submerged balloons were described as being filled with air. However, other materials could also be used to fill the balloons provided that they are of lower density than water. Certain polymers have lower density than water and could be used to fill the balloons, as well as certain ceramics. Light oils with less density than water could also be used. Air is expected to be the most economical and best performing material for submerged systems, but there may be an advantage to using other materials, such as incompressibility. The term balloon has been widely used, however, any buoyant object, either having constant volume or variable volume, attached to a tether could be employed in place of a balloon; an air filled balloon is simply thought to be the lowest cost buoyant body available. Even though balloons have been shown and described herein as being spherical, they can be of any other suitable shape such as oblong. As stated previously, buoyant objects could be made in a cost effective manner by employing plastic or metal pipes capped at both ends and employed either individually or in clusters or by using other existing pressure vessels, such as steel cylinders.

In aerial systems, any gas with lower density that air would be appropriate. Hydrogen is likely to be the most economical and best performing gas for aerial based systems.

A steel cylinder such as those employed to hold pressurized gasses for transportation and storage could replace the underwater balloon as a buoyant body in the system. Pipes, including plastic and metal pipes such as those for distributing water and oil, can also be employed in place of underwater balloons as a buoyant body provided they are capped. Other potential buoyant bodies to use in place of underwater balloons are hollow spheres made of polymer or hollow spheres made of glass. These could be made in a variety of ways including injection moulding. Many hollow spheres could be grouped together in a mesh net to act as a large buoyant body. Stiff, thin walled spheres could resist very high pressures that would occur at depths because their walls would be in nearly perfect compression as the force of pressure across the whole face of the sphere would be nearly equal, with a small variation from the top of the sphere to the bottom of the sphere due to the difference in relative depth. However this difference would be small in spheres with diameters of around 10 cm and wall thickness of around 1 mm.

In order to secure the pulley in the system to the seabed it would be possible to construct a barge to which the pulley would be connected to this barge. This barge could then be weighed down and sunk to serve as an anchor for the system.

The pulley on the system is potentially the most complex part of the system. The bearings in the system must be very strong as the forces on the cable can be very large. Additionally, at deep depths there will be high-pressure forces that could cause water to penetrate the sealed bearing compartments. As such bearings that do not require lubrication would be preferable. An open ball bearing system where water was allowed to flow freely through the bearings would be simpler to make. The ceramic alloy created by combining a metal alloys of boron, aluminum and magnesium (AIMgB14), commercially referred to as BAM is a very low friction material which is also extremely hard (it is presently the second hardest known material after diamond). BAM can be coated either onto the ball bearings themselves, onto the races where they sit, or onto both. BAM is made slicker in the presence of water and no other lubricant would be necessary. Sleeve bearings can also be employed instead of ball bearings and can also employ BAM as a slick surface. Any other slick surfaces could be employed to make this ball bearing. Additionally, a traditional sealed bearing with grease would also be possible.

Further, rather than using a pulley, a cable guided in a groove with a non-stick surface made using BAM or another similar material would also be possible. This would increase wear but be easier to manufacture.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. An energy storage system comprising:
a buoyant object to be disposed in a body of water, the body of water overlying a seafloor;
a tether to secure to the buoyant object;
a motor operationally connectable to the tether to lower the buoyant object in the water to obtain a lowered buoyant object, the motor being disposed outside the water;
a generator operationally connectable to the tether, the generator to generate power upon release of the lowered buoyant object and a rise of the buoyant object in the water, the generator being disposed outside the water; and
a pulley disposed on the seafloor, the pulley to guide the tether from the motor and the generator to the buoyant object.

2. The system of claim 1 further comprising a reel, the reel to connect to the motor and to the generator, the reel to reel-in a length of the tether upon being turned by the motor to lower the buoyant object in the water, the reel to reel-out the length of the tether and to turn the generator upon the rise of the buoyant object in the water.

3. The system of claim 1 wherein the buoyant object is a balloon.

4. The system of claim 1 wherein the balloon occupies an initial volume when subjected to atmospheric pressure, the balloon being filled with air at a first pressure, the balloon to be lowered in the water to a pre-determined depth, the water exerting a second pressure on the balloon at the pre-determined depth, the first pressure being greater than the second pressure to allow the balloon to substantially maintain its initial volume when at the pre-determined depth.

5. The system of claim 1 wherein the motor includes one of an electrical motor and a combustion engine.

6. The system of claim 1 wherein the generator includes an electrical generator.

7. The system of claim 1 further comprising:
a floating structure to be disposed on the water, the motor and the generator being disposed on the floating structure.

8. The system of claim 1 wherein the body of adjacent a shore, the motor and the generator being disposed on the shore.

9. The system of claim 1 further comprising a ballast connected to the pulley, the ballast to secure the pulley to the seafloor.

10. The system of claim 1 wherein the buoyant object is a stiff-walled structure.

11. An energy storage system comprising:
a buoyant object to be disposed in a fluid;
a tether to secure to the buoyant object; and
a motor-generator unit operationally connectable to the tether, the motor-generator unit to receive electrical power to lower the buoyant object in the fluid to obtain a lowered buoyant object, the motor-generator unit to generate electrical power upon a release of the lowered buoyant object and a rise of the lowered buoyant object in the fluid.

12. The system of claim 11 further comprising a reel, the reel to connect to the motor-generator unit, the reel to reel-in a length of the tether upon being turned by the motor-generator unit to lower the buoyant object in the fluid, the reel to reel-out the length of the tether and to turn the motor-generator unit upon the rise of the buoyant object in the fluid.

13. The system of claim 12 wherein the buoyant object is a balloon and the fluid is air.

14. The system of claim 13 wherein the balloon is filled with at least one of hydrogen and helium.

15. The system of claim 13 wherein the balloon has a volume, the volume being variable from an initial volume to an expanded volume, the balloon having a negative buoyancy at the initial volume and a positive buoyancy at the expanded volume.

16. The system of claim 15 wherein the volume of the balloon increases from the initial volume to the expanded volume upon absorption of thermal energy, the expansion of the volume causing the balloon to rise in the air.

17. The system of claim 16 wherein the balloon absorbs thermal energy upon being illuminated by the Sun.

18. An energy storage system comprising:
a buoyant object to be disposed in a fluid;
a tether to secure to the buoyant object; and
a mechanical unit including at least one of a hand crank, a water turbine, and a wind turbine, the mechanical unit being operationally connectable to the tether to lower the buoyant object in the fluid to obtain a lowered buoyant object;
a generator operationally connectable to the tether, the generator to generate power upon release of the lowered buoyant object and a rise of the buoyant object in the fluid, the generator being disposed outside the water; and
a pulley to guide the tether from the motor and the generator to the buoyant object.
